(19) United States
(12) Patent Application Publication
(10) Pub. No.: US 2004/0170370 A1
(43) Pub. Date: Sep. 2, 2004

(54) Sealing device

(75) Inventor: Hans-Detlef Leppert, Monchengladbach (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/685,428

(22) Filed: Oct. 16, 2003

(30) Foreign Application Priority Data
Nov. 25, 2002 (EP) 02360323.6

(51) Int. Cl. G02B 6/00

(52) U.S. Cl. 385/136

(57) ABSTRACT

Sealing device for sealing a cable against a pipe or pipe branch characterized in that the sealing device comprises a tubular body which is connectable to a cable by electro-fusion at one side and which is attachable to a pipe or pipe branch at the opposite side.

### BACKGROUND OF THE INVENTION

The invention relates to a sealing device for sealing a cable against a pipe or pipe branch, wherein the sealing device comprises a tubular body which is connectable to a cable by electro-fusion at one side.

Cables, in particular optical fiber cables, are often installed in buildings, plants, customer premises as well as in trunk-, metro- and access networks using already existing pipe infrastructures inside and outside of buildings. For example, cables are installed in gas, drinking water, sewage, or heating pipes. The cables must enter and exit the pipe system at certain locations. The fluid carried in the pipe system must not leave the pipe system at the points of entry and exit of the cable from the pipe system. Hence, the cable must be sealed against the pipe or a pipe branch where the cable enters or leaves the pipe system.

It is known to use multiple rubber seals for sealing the cable against the pipe. However, care must be taken not to affect the cable by applying too much radial pressure on the cable and on the other hand to still effect efficient sealing. Furthermore, rubber seals, in particular rubber sealing rings take up a certain amount of radial space. Hence the spacing between the cable and the inside of the pipe must be sufficiently large. The annular space between cable and pipe must be calculated exactly and the rubber seals must be manufactured accordingly. Additionally, rubber seals tend to age and therefore need maintenance.

From US 2002/0083976 A1 it is known to insert access fittings into a gas pipe and to introduce a service line conduit via a side branch of the access fittings. The service line conduit is sealed against the side branch by an electro-fusion reducer coupling, which is attached to the sidebranch and to the service line conduit by electro-fusion.

In U.S. Pat. No. 5,127,630 a method for inserting cables within a pipe is described. One end of the pipe is closed with a cap having an opening or part for introducing a flow of an agent and having a plurality of closed entry channels. One of said entry channels is opened and a cable is inserted through said opened entry channel. The cap is secured to the end of the pipe with a clip or band.

### SUMMARY OF THE INVENTION

It is the object of the invention to provide a sealing device for sealing cables against pipes or pipe branches which can be easily installed and which does not require maintenance.

This object is achieved by a sealing device for sealing a cable against a pipe or pipe branch wherein the sealing device comprises a tubular body which is connectable to a cable by electro-fusion at one side and which is attachable to a pipe or pipe branch at the opposite side by screwing or clamping. The sealing device is attachable to the pipe or pipe branch and thus forms a fluid-tight connection with the pipe or pipe branch. To this end an adapter may be provided between the sealing device and the pipe or pipe branch in order to facilitate attachment. The stem of p.ex. a saddle fitting is in this context also regarded as pipe branch. The sealing device is attached to the cable by electro-fusion. This requires at least part of the inside of the tubular body of the sealing device, in which the cable is guided, and at least the part of the outer layer of the cable being guided in the pipe inlet or outlet to be of plastic, for instance polyethylene (PE). Application of heat causes the cable to be fused to the inside of the sealing device and vice versa. Thus, a permanent, non-aging seal between the cable and the pipe can be easily realized. Fluid, i.e. liquid or gas, cannot escape from the pipe system.

If the pipe or pipe branch are not made of plastic, the sealing device cannot be attached by electro-fusion. However, a sealing engagement can be obtained by screwing or clamping the sealing device to the pipe. It is also possible to attach an adapter made of plastic to the pipe or pipe branch, p.ex. by screwing the adapter into or on the pipe or pipe branch and to attach the sealing device to the adapter by electro-fusion. Preferably, the opposite side of the sealing device is designed such that it can either be screwed or clamped to the pipe and attached by electro-fusion, depending on the material the pipe is made of. Thus, only one type of sealing device is needed, independent of the material of the pipe.

In a particularly preferred embodiment the opposite side is attachable to the pipe or pipe branch by electro-fusion. If both sides of the sealing device are connected by electro-fusion, a particularly good seal between the cable and the pipe can be obtained which does not require maintenance. This requires the part of the pipe or pipe branch where the cable enters or exits the pipe system and the inside of the sealing device to be of plastic.

If the inner cross-section of the side connectable to the cable is adapted to the shape of the cable, a good sealing contact can be ensured. Preferably, the outside of the cable and the inside of the sealing device touch already prior to electro-fusion.

In a further preferred embodiment the inner diameter of the opposite side is adapted to the outer shape of the pipe or pipe branch. In particular, if electro-fusion is to be used for attaching the sealing device to the pipe, a snug fit of the sealing device on the pipe ensures that a sealing contact between the sealing device and the pipe is obtained after electro-fusion.

Electro-fusion can be carried out particularly easily if the sealing device is made of polyethylene, in particular high density polyethylene (HDPE). HDPE is particularly suited for electro-fusion.

In an advantageous embodiment the body comprises at least in sections an electrical resistance heating wire embedded in a skin layer. The wire or a winding of such a wire can be located in close proximity of the layer to be fused to the cable and/or pipe. Hence, the wire can be used to heat the sealing device and the cable and/or the pipe at the location, where the parts are to be fused together.

In a further development the wire consists of copper. Copper is particularly suited for electrical resistance heating.

Further advantages can be extracted from the description and the enclosed drawing. The features mentioned above and below can be used in accordance with the invention either individually or collectively in any combination. The embodiments mentioned are not to be understood as exhaustive enumeration but rather have exemplary character for the description of the invention.

### BRIEF DESCRIPTION OF THE DRAWINGS

The invention is shown in the drawing.

FIG. 1 shows a cross-section through a pipe section and a sealing device;

FIG. 2 shows the sealing device fused to a pipe branch and a cable; and

FIG. 3 shows an alternative embodiment of the sealing device.

### DETAILED DESCRIPTION OF THE DRAWINGS

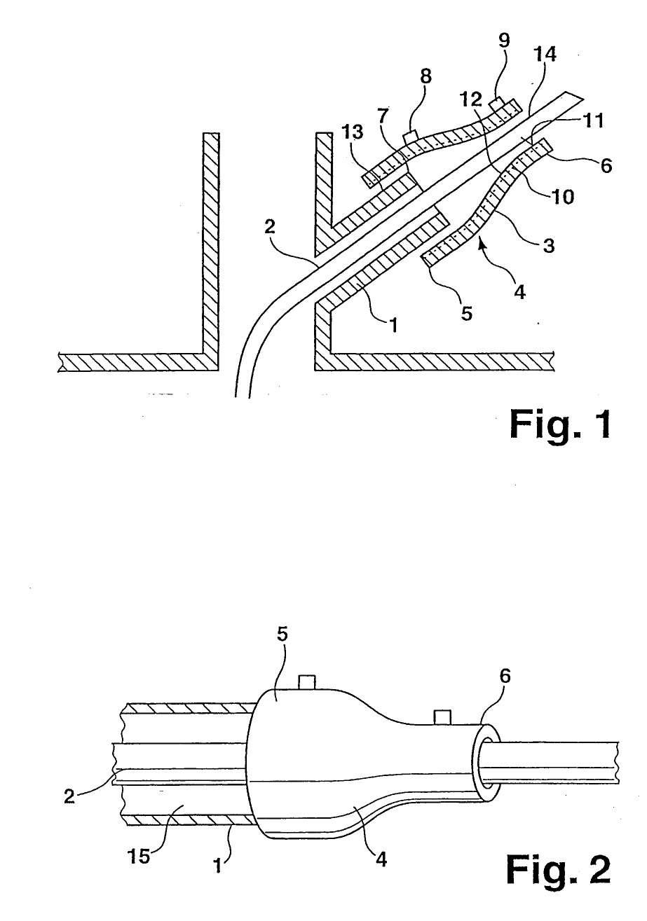

In FIG. 1 a plastic pipe branch 1 is shown in cross-section which is used as exit point of a cable 2. The cable 2 passes through the pipe branch 1 and the tubular body 3 of a sealing device 4 made of plastic material. The outer material of the cable 2 is the same as that of the sealing device 4. With one end 5, having a larger diameter than the opposite end 6, the sealing device 4 is pushed over the free end 7 of the pipe branch 1. The sealing device 4 is provided with electrodes 8, 9 being in contact with a copper wire 10 located in the vicinity of the inner surface 11 of the sealing device 4. Hence, the wire 10 is separated from the inner surface 11 by a thin material layer 12 only. By supplying a current to the wire 10 through the electrodes 8, 9, the heat necessary for fusion is generated by resistance heating. Thus, the end 5 of the sealing device 4 is fused to the outer surface 13 of the pipe branch 1. At the same time the end 6 is fused to the outer surface 14 of the cable 2. Consequently, a fluid-tight seal between the pipe branch 1 and the cable 2 is obtained.

FIG. 2 shows the sealing device 4 of FIG. 1 being fused at one end 6 to the cable 2 and at the opposite end 5 to the pipe branch 1 which is shown in cross-section. A fluid-tight connection is obtained between the pipe branch 1 and the sealing device 4 as well as between the cable 2 and the sealing device 4. Fluid present in the space 15 cannot escape from the pipe branch 1.

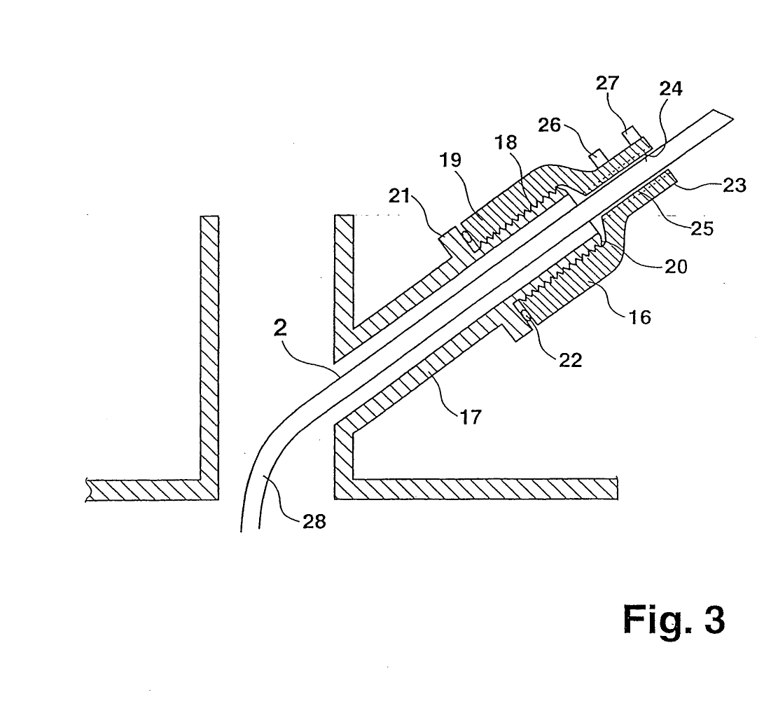

FIG. 3 shows an alternative embodiment of a sealing device 16, which is attached to a non-plastic pipe branch 17. The sealing device 16 comprises an internal screw thread 18 on one side 19, which is used to screw the sealing device 16 onto the free end 20 of the pipe branch 17 which comprise a mating thread for the sealing device 16 to be screwed on. The pipe branch 17 comprises a steel ring 21. Between the steel ring 21 and the sealing device 16 is provided a sealing ring 22 made of rubber to seal the sealing device 16 against the pipe branch 17. The sealing ring 22 is pressed against the steel ring 21 by the sealing device 16. On the side 23, the sealing device 16 has a smaller diameter than on the side 19. In the vicinity of its inner surface 24 is provided a winding of a resistance heating wire 25, which can be connected to a voltage supply by means of the electrodes 26, 27. The side 23 can thus be electro-fused to the outside of the cable 28, which passes through the pipe branch 17 and the sealing device 16. The outer layer of the cable 28 is made of plastic.

1. Sealing device for sealing a cable against a pipe or pipe branch wherein the sealing device comprises a tubular body which is connectable to a cable by electro-fusion at one side, characterized in that the opposite side is attachable to the pipe or pipe branch by screwing or clamping or an adapter made of plastic and connected to the opposite side by electro-fusion is attachable to the pipe or pipe branch by screwing.

2. Sealing device according to claim 1, characterized in that the opposite side is attachable to the pipe or pipe branch by electro-fusion.

3. Sealing device according to claim 1, characterized in that the inner cross-section of the side connectable to the cable is adapted to the shape of the cable.

4. Sealing device according to claim 1, characterized in that the inner diameter of the opposite side is adapted to the outer shape of the pipe or pipe branch.

5. Sealing device according to claim 1, characterized in that the sealing device is made of polyethylene, in particular high density polyethylene.

6. Sealing device according to claim 1, characterized in that the body comprises at least in sections a wire embedded in a skin layer.

7. Sealing device according to claim 6, wherein the wire consists of copper.
